(19) United States
(12) Patent Application Publication
(10) Pub. No.: US 2008/0109741 A1
(43) Pub. Date: May 8, 2008

(54) USER-GENERATED CONTENT WITH INSTANT-MESSAGING FUNCTIONALITY

(75) Inventors: Bill Messing, Seattle, WA (US); Jan S. Drake, Seattle, WA (US); Nils B. Lahr, Redmond, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: RIPL CORP., Seattle, WA (US)

(21) Appl. No.: 11/934,587

(22) Filed: Nov. 2, 2007

Related U.S. Application Data
(60) Provisional application No. 60/864,094, filed on Nov. 2, 2006.

(51) Int. Cl. G06F 3/048; G06F 15/16

(52) U.S. Cl. 715/764; 709/206

(57) ABSTRACT

Methods, apparatuses, and articles for user computing devices and a server are described herein. In various embodiments, a first computing device may receive an object or message associated with a user of a second computing device and may visually manifest the object or message to a user. In response to detecting a user interaction with the visual manifestation of the object or message, the first computing device may change the visual manifestation of the object or message to facilitate the user of the first computing device in engaging the user of the second computing device in an instant messaging conversation, the changed visual manifestation of the object or message serving as a user interface of an instant messaging client of the first computing device. In some embodiments, a server may associate an instant messaging client with the object or message and may transmit both to the first computing device.

### RELATED APPLICATIONS

The present non-provisional application claims priority to provisional application No. 60/864,094, entitled “User-Generated Content with Instant-Messaging Functionality”, filed Nov. 2, 2006.

### TECHNICAL FIELD

The present invention relates generally to the field of data processing. More specifically, the present invention relates initiating an instant messaging conversation by interacting with content associated with the instant messaging recipient, the content effectively serving as a user interface of an instant messaging client.

### BACKGROUND

Many ways exist to share “user-generated content,” such as photos, videos, text entries, and other content that is produced or distributed by end users of the World Wide Web and other electronic networks. Such ways in which content is shared include the following: attaching it to email, attaching it to instant-messaging sessions, and posting it to web pages.

Also, many users have adopted “instant messaging” (“IM”) services to communicate with friends, family, colleagues, and other acquaintances. Popular IM client software includes AOL Instant Messenger (AIM), ICQ, MSN Messenger, Yahoo Messenger, and similar client-based solutions.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an overview of content publication in a social network suitable for practicing embodiments of the present invention;

FIG. 2 illustrates an overview of various embodiments of the present invention;

FIG. 3 illustrates a flowchart view of selected user computing device operations, in accordance with various embodiments;

FIG. 4 illustrates a flowchart view of selected server operations, in accordance with various embodiments;

FIG. 5 illustrates an object/content displayed to a recipient and indicia of whether the a user associated with the object/content is available to participate in an IM conversation, in accordance with various embodiments;

FIG. 6 illustrates the initiating of an instant messaging conversation by hovering a cursor over an object/content, in accordance with various embodiments; and

FIG. 7 illustrates an example computer system suitable for use to practice various embodiments of the present invention.

### DETAILED DESCRIPTION OF ILLUSTRATIVE EMBODIMENTS

Illustrative embodiments of the present invention include, but are not limited to, methods and apparatuses for user computing devices and a server. In various embodiments, a first computing device may receive an object or message associated with a user of a second computing device and may visually manifest the object or message to a user. In response to detecting a user interaction with the visual manifestation of the object or message, the first computing device may change the visual manifestation of the object or message to facilitate the user of the first computing device in engaging the user of the second computing device in an instant messaging conversation, the visual manifestation of the object or message serving as a user interface of an instant messaging client of the first computing device. In some embodiments, a server may associate an instant messaging client with the object or message and may transmit both to the first computing device.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

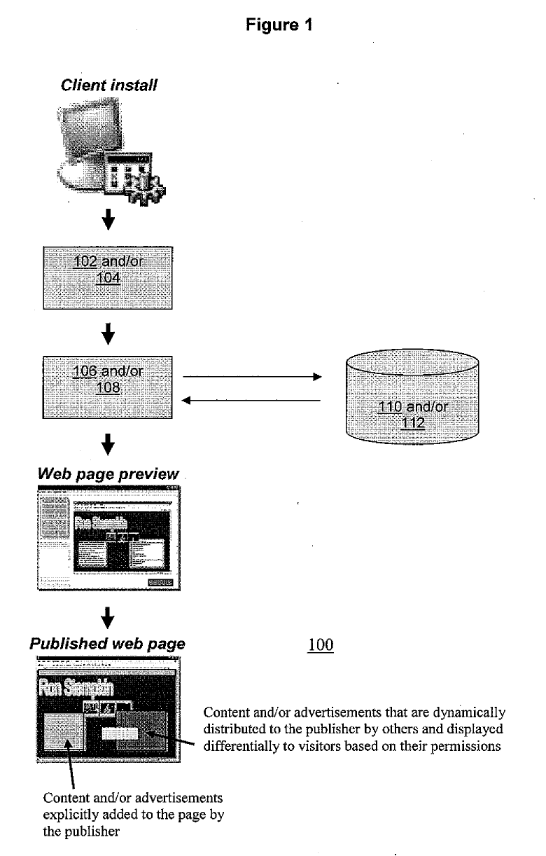

FIG. 1 illustrated an overview of content publication to user computing devices in a social network, suitable for practicing the present invention. The social network system 100, as illustrated, may present to each user of the system a set of constantly changing content that the user might find interesting. The content may originate within the system or from external sources available to the system, such as from other users. The content may be published substantially automatically, based upon a broad set of discovery methods. These methods, in various embodiments, may look at factors such as a person's social network, what music the members of the social network are listening to, how the members behave at one or more web sites, and so forth. These discovery methods may be designed to require relatively little action on behalf of the user. In one embodiment, friends of the user may also be members of the social network. This social network could be embodied via a web site or via some other electronic mechanism. The electronic mechanism by which the users interact is hereinafter referred to as the “social network.” The members may listen to music or take photographs or browse through the social network. All of these may be considered natural actions for users of the system. From the simple act of having friends and interacting with the social network, the user may be provided by the system with a constantly changing set of content. This content, in various embodiments, may be delivered directly to the user's desktop in addition to their home page on the social network. While the content of the social network may be delivered via a web site, it may also, in alternate embodiments, be delivered to other devices of the user—such as the user's personal digital assistant, cell phone, portable media player and so forth.

The social networking system may combine this constantly changing content with another aspect: the system may expose what the system is delivering to a user's desktop to anyone who visits the user's home page. For example, suppose that the system is showing user A content items 1, 2 and 3 on A's desktop. These items may appear on user A's desktop as well as on user A's home page on the social network. If visitor B goes to user A's home page, visitor B may also see content items 1, 2 and 3. Thus, user B may receive objects/content associated with user A via the social network.

In various embodiments, the social network system may be endowed with several services:
A Content Selection Service 102 for selecting material to display to the user based on social network activity
An Advertisement Selection Service 104 for selecting advertisements that are published and/or viewed by a specific user
A Rights Filtering Service 106 to filter contents/advertisements to be transmitted
A Content Merging Service 108 to merge content and advertisements
A Content Metadata Store 110 to facilitate content selection
A Content Store 112 for storing content.

Given these services 102-108, when a User A views a page for a User B, the system may determine what to show User A. First, it may call Content Selection Service 102 to get content for User B. Next, it may call the Advertisement Selection Service 104 to get advertisements for User B's page. Content Selection Service 102 content may then hand off to Rights Filter Service 106 so that only content User A is allowed to see may be transmitted. These sets of content and the advertisements may then be merged together by the Content Merging Service 108 and transmitted to User A.

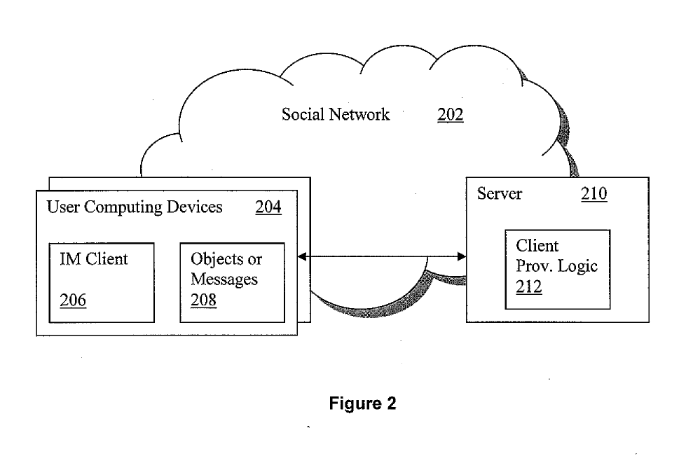

FIG. 2 illustrates an overview of various embodiments of the present invention. As illustrated, a plurality of user computing devices 204 (referred to variously herein as “user devices” and “computing devices”) may belong to a social network 202. A first of these user computing devices 204 may receive an object or message 208 associated with a user of a second user computing device 204. The first user computing device 204 may also have or receive and instant messaging (hereinafter “IM”) client 206. IM client 206 may have been received from server 210, server 210 having client providing logic 112 for providing IM clients 206 to user computing devices 204. In various embodiments, the first user computing device 204 may visually manifest, on the first computing device, the object or message 208 to enable viewing of the object or message 208 by a user of the first user computing device 204. In response to detecting a user interaction with the visual manifestation of the object or message 208, the first user computing device 204 may change the visual manifestation of the object or message 208 to facilitate the user of the first user computing device 204 in engaging the user of the second user computing device 204 in an instant messaging conversation, the changed visual manifestation of the object or message 208 serving as a user interface of instant messaging client 206. In some embodiments, user computing devices 204 and server 210 may be communicatively coupled by a networking fabric (not shown). Such a networking fabric may be any known in the art, such as a LAN, a WAN (public or private), or the Internet, and may be either partially or entirely wired or wireless.

In various embodiments, server 210 may determine which objects/content 208 of a first user computing device 204 should be provided to a second user computing device 204. Client providing logic 212 of server 210 may also associate an IM client 206 with an object/content 208, the object/content 208 to serve as a user interface of the IM client 206 on the second user computing device 204 in response to a user interaction with a visual manifestation of the object/content 208. In some embodiments, server 210 may then transmit the object/content 208 and IM client 206 to the second user computing device 204.

As illustrated and described above, social network 202 may connect users of a plurality of user computing devices 204. In various embodiments, social network 202 may be the social network system 100 described above and illustrated in FIG. 1. In such embodiments, objects or messages 208 may be distributed by Content Selection Service 102 and/or Advertisement Selection Service 104. In other embodiments, social network 202 may be a different social network, such as a social network established by known contact lists of IM clients 206 (often referred to as “buddy lists”) and/or by an instant messaging service. In yet other embodiments, social network 202 may comprise a list trusted and non-trusted social connections generated by server 210 based on intersections of data describing user computing devices 204. Social network 202 may comprise any knowledge base of connections between users of user computing devices 204 with indications of those connections being available to some or all of user computing devices 204. In one embodiment, server 210 may enroll users of user computing devices 204 to be members of social network 202.

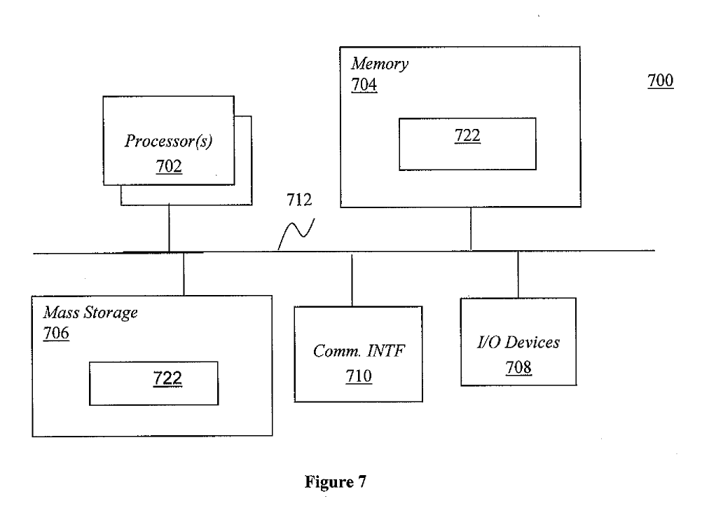

In various embodiments, user computing devices 204 and/or server 210 may each be one or more of any sort of computing device known in the art, except for IM client 206, objects or messages 208, client providing logic 212, and other logic adapted to perform the operations described more fully herein. User computing devices 204 and/or server 210 may each be a personal computer (PC), a workstation, a server, a router, a mainframe, a modular computer within a blade server or high-density server, a personal digital assistant (PDA), an entertainment center, a set-top box or a mobile device. Further, user computing devices 204 and/or server 210 may each be any single- or multi-processor or processor core central processing unit (CPU) computing system known in the art, except for IM client 206, objects or messages 208, client providing logic 212, and other logic adapted to perform the operations described more fully herein. An exemplary single-/multi-processor or processor core user computing device 204 or server 210 is illustrated by FIG. 7, and will be described in greater detail below.

In various embodiments, as described a first user computing device 204 may receive objects or messages 208, and may receive or already have IM client 206. In some embodiments, the user of the first user computing device 204 may be a user of the social network system 100/social network 202, and the first user computing device 204 may include client logic (not shown) to facilitate the operations shown in FIG. 1 and described above in greater detail. First user computing device 204 may possess one or more modules of logic to perform the operations described above and below. In various embodiments, such logic may be any one or more single- or multi-threaded processes.

In some embodiments, first user computing device 204 may receive objects or messages 208 from server 210. As mentioned above, objects or messages 208 may comprise objects/content distributed by a Content/Advertisement Selection Service 102/104. In various embodiments, such received objects 208 may include one or more of a photo, a video clip, a text object, an audio clip, an audiovisual object, location information (such as a global positioning system (GPS) location, a local networking hotspot identifiers, or Bluetooth location information) or a product (such as a product in local proximity to the first user computing device 204, the product having been sensed by a video input, a radio frequency identifier (RFID), or any other localized identifying system). Messages 208 may include a notification of a user of a second user computing device 204's proximity, or a notification of an event associated with both a user of the first user computing device 204 and the user of the second user computing device 204. As previously stated, object or message 208 may be associated with the user of the second user computing device 204. In one embodiment, the association may be that the object 208 is local to and/or displayed on the second user computing device 204. In another embodiment, the user of the second user computing device 204 may have transmitted the object 208 directly to the user of the first user computing device 204 though, for example, an instant message or email, and the association may be established by that transmission. In some embodiments, message 208 may be associated with the user of the second user computing device 204 by referring to the user. The first user computing device 204 may determine or note the association from either metadata received with the object or message 208, from the identity of the sender, from a message provided by server 210 with the object or message 208, or from an analysis of the object or message 208 itself, in various embodiments.

In some embodiments, as described above, first user computing device 204 may visually manifest, on the first user computing device 204, the object or message 208 to the user of the first user computing device 204 to enable the user to view the object or message 208. In some embodiments, the visual manifesting may involve rendering the object or message 208 on a display of the first user computing device 204. The object of message 208 may be rendered, for example, on a desktop or website displayed on the first user computing device 204. For visual or audiovisual objects 208, such as photos or videos, the objects 208 may be manifested as they are. For other objects 208, such as audio objects, a visual representation, such as an audio player window, may be rendered to the user. For yet other objects 208, such as location information or a product, a visual representation may be manifested/rendered to the user. Messages 208 may be associated with a textual display to be visually manifested to the user.

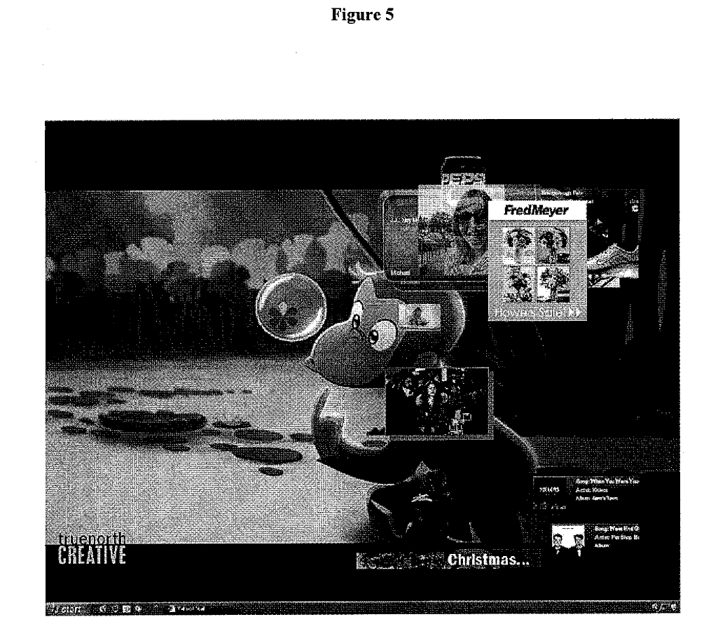

In various embodiments, first user computing device 204 may also visually manifest, on the first user computing device 204, an indication of whether the user of the second user computing device 204 is online/available for an instant messaging conversation. First user computing device 204 may determine if the user of the second user computing device 204 is online available by making a status inquiry of the second user computing device 204, of server 210, or of another IM- or social network 202-related server. In one embodiment, first user computing device 204 may render an outline around the visual manifestation of the object or message 208 to indicate that the user of the second user computing device 204 is available. In other embodiments, other visual cues may be used. An exemplary visual manifestation showing an object 208 and an outline around the object to indicate an available status is illustrated by FIG. 5, and is described further below.

As illustrated and described above, first user computing device 204 may also comprise an IM client 206. In some embodiments, the IM client 206 may possess some functionalities similar to IM clients known in the art, such as providing message sending and receiving capabilities and maintaining a “buddy list” of known IM contacts. In other embodiments, IM client 206 may simply comprise an object, such as a JavaScript object, provided by server 210. For example, such an IM client 206 may be a text input control of a form embedded in a web page, the web page comprising a text field conditionally showed based on user interaction and the object or message 208. IM client 206 may utilize the object or message 208 as its user interface rather than possessing and rendering a separate, object or message 208-independent user interface. In some embodiments, IM client 206 may be local to first user computing device 204, having been previously installed. In other embodiments, IM client 206 may be provided with the object or message 208 (such as when IM client 206 is a JavaScript object).

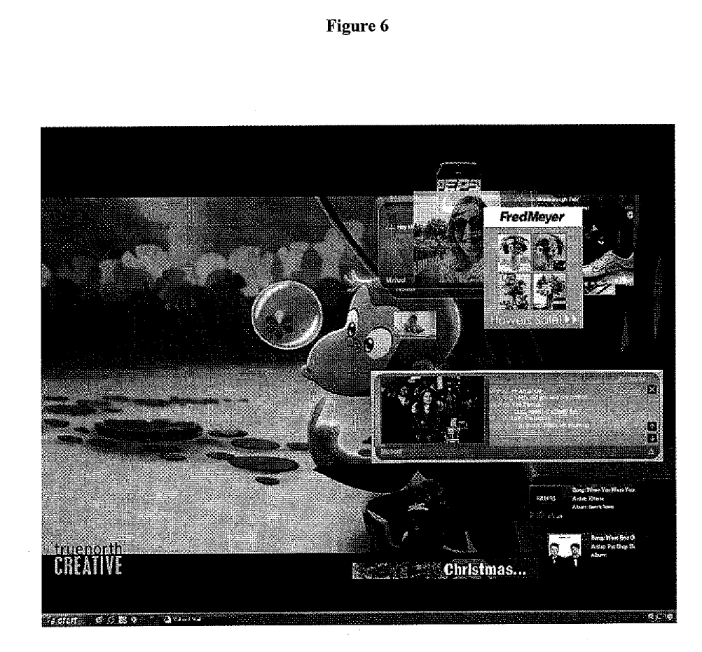

In various embodiments, first user computing device 204 may detect a user interaction with the visual manifestation of the object or message 208. In some embodiments, a user may move a mouse of the first user computing device 204, causing the cursor display, which may serve as a visual manifestation of a mouse position, to hover over the visual manifestation of the object or message 208. If the user of the second user computing device 204 is shown as being online/available, the user of the first user computing device 204 may start an instant messaging conversation with a user of the second user computing device 204 simply by hovering the cursor over the visual manifestation of the object or message 208 and by starting to input a message though, for example, typing or speaking. In response to these user interactions, the first user computing device 204 may change the visual manifestation of the object or message 208 to facilitate the instant messaging conversation. In some embodiments, the changing of the visual manifestation of the object or message 208 may include providing a text entry area in association with the visual manifestation of the object or message 208 to receive and render textual input from the user of the first user computing device 204. An exemplary changed visual manifestation showing an object 208 and text input next to the object 208 is illustrated by FIG. 6, and is described further below.

In one embodiment, in response to detecting the user interaction with the visual manifestation of object or message 208, first user computing device 204 may initiate an email to or a live video session with the user of the second user computing device 204. To enable these operations, first user computing device 204 may also possess an email client and/or video software and hardware, object or message 208 also serving as at least a partial user interface for the email client and/or video software.

In some embodiments, upon receiving a message input from the user of the first user computing device 204, the first user computing device 204 may transmit the message to the user of the second user computing device 204. In one embodiment, the message may be transmitted through an IM server or a server of social network 202. In other embodiments, the message may be transmitted directly to the user of the second user computing device 204. Upon receipt, the second user computing device 204 may visual manifest the instant message in association with a visual manifestation of the object or message 208, the object or message 208 serving as a user interface of an IM client 206 of the second user computing device 204. Users of the first and second user computing device 204 may then interact with the visual manifestations of the object/message 208 and associated input areas in a similar manner.

As illustrated and described above, server 210 may comprise client providing logic 212 to associate an IM client 206 with an object/content 208 and to provide the IM client 206 and object/content 208 to user computing devices 204. As mentioned above, server 210 may be a server of social network 202/social network system 100. Server 210 may possess one or more modules of logic to perform the operations described above and below. In various embodiments, such logic may be any one or more single- or multi-threaded processes. Also, as mentioned above, server 210 may enroll users of user computing devices 204 to be members of social network 202.

In some embodiments, server 210 may be a content selecting/providing server capable of determining whether an object/content of one user computing device 204 should be shared with another. In various embodiments, such determining may be made in response to one or more rules or preferences, and/or based on a buddy list of either or both of the user computing devices 204. In one embodiment, as mentioned above, the determining may be made based on intersections of data describing user computing devices 204. Prior to transmitting the object/content 208 from one user computing device 204 to another, the server 210 may, in some embodiments, associate an IM client 206 with the object/content 208, the object/content 208 to serve as a user interface of the IM client 206 on the recipient user computing device 204 in response to a user interaction with a visual manifestation of the object/content 208, as described above. In one embodiment, the associating may simply comprise generating a JavaScript object, such as a text entry area, and associating the JavaScript object with the object/content 208. In other embodiments, the IM client 206 may comprise client logic which must be installed on the recipient user computing device 204 when received. The server 210 may then transmit the IM client 206 and object/content 208 to the recipient user computing device 204. In alternate embodiments, server 210 may actually have provided IM client 206 at a previous time, and may provide object/content 208 on its own. In yet other embodiments, server 210 may not provide IM client 206 at all, that being performed by another server 210.

In various embodiments, instead of sharing objects/content 208 between user computing devices 204, server 210 may send messages 208 to the user computing devices 204, such as the sort of messages 208 described above. Server 210 may determine user computing device 204 locations and/or user activities from the user computing devices 204 themselves or from other systems. In response to determining a location or activity connecting users of user computing devices 204, server 210 may transmit messages 208 to those user computing devices 204 to inform their users of the connection. In some embodiments, server 210 may associate an IM client 206 with the messages 208 and may transmit the client 206 with the messages 206, as described above with regard to objects/content 208.

In some embodiments, server 210 may further receive an instant message from the recipient user computing device 204. Server 210 may next transmit IM client 206 and the instant message to the other user computing device 204 (the one from which the object/content 208 was shared), to facilitate display of the instant message on the other user computing device 204 in conjunction with the object/content 208, the object/content 208 also serving as a second user interface of the IM client 206 on the other user computing device 204. In one embodiment, server 210 may second transmit the IM client 206 and the instant message to some or all of a plurality of user computing devices 204 known to server 210 as having the object/content 208.

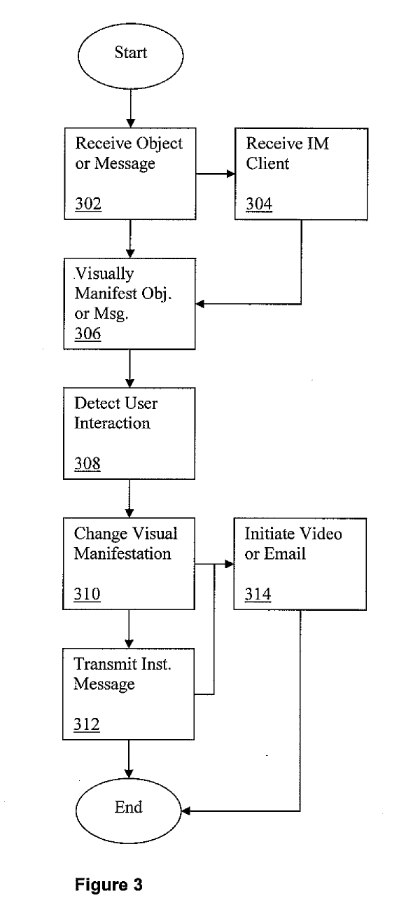

FIG. 3 illustrates a flowchart view of selected user computing device operations, in accordance with various embodiments. As illustrated, a first computing device may receive an object or message associated with a user of a second computing device, block 302. In some embodiments, the object or message may be one of a photo, a video clip, a text object, an audio clip, an audiovisual object, location information, a product, a notification of the user of the second computing device's proximity, or a notification of an event associated with both a user of the first computing device and the user of the second computing device. In various embodiments, the users of the first and second computing devices may be members of a social network. In one embodiment, the first computing device may also receive an instant messaging client with the object or message, block 304, the instant messaging client being associated with the object or message. In other embodiments, the instant messaging client may already be local to the first computing device, and the user of the second computing device may be an instant messaging contact known to the instant messaging client.

In various embodiments, the first computing device may then visually manifest the object or message on the first computing device to enable viewing of the object or message by the user of the first computing device, block 306. In one embodiment, the visually manifesting may include facilitating the user of the first computing device in determining whether the user of the second computing device is available for an instant messaging conversation. As is further shown, the first computing device may then detect a user interaction with the visual manifestation of the object or content, block 308, the interaction comprising a mouse-over of the visual manifestation of the object or message.

As illustrated, the first computing device may then, in response to detecting the user interaction with the visual manifestation of the object or message, change the visual manifestation of the object or message to facilitate the user of the first computing device in engaging the user of the second computing device in an instant messaging conversation, block 310, the changed visual manifestation of the object or message serving as a user interface of the instant messaging client of the first computing device. In some embodiments, the facilitating may include facilitating the user of the first computing device in creating an instant message to send to the user of the second computing device. Also, in one embodiment, the changing of the visual manifestation of the object or message may include providing a text entry area in association with the visual manifestation of the object or message to receive and render textual input from the user of the first computing device. Then, as further shown, the first computing device may transmit the instant message to the user of the second computing device, block 312.

As further shown, the first computing device may also, in one embodiment, in response to detecting the user interaction with the visual manifestation of the object or message, initiate an email to or a live video session with the user of the second computing device, block 314.

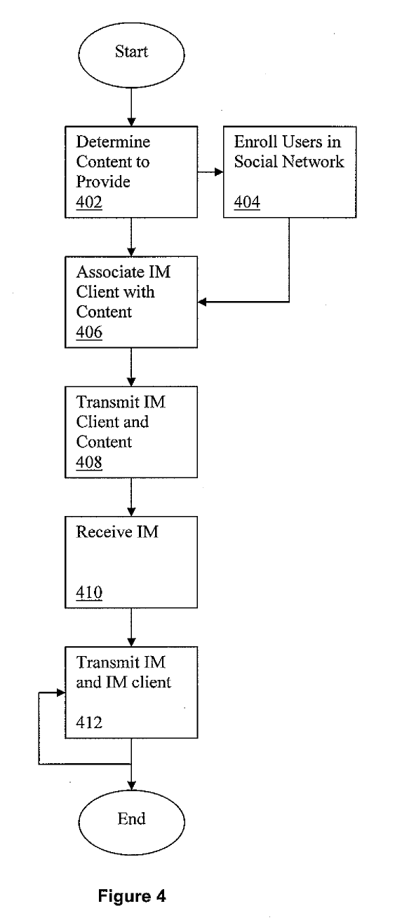

FIG. 4 illustrates a flowchart view of selected server operations, in accordance with various embodiments. As illustrated, a server may determine that content of a first user device is to be provided to a second user device, block 402. In one embodiment, the server may users of first and second user devices to be members of a social network, block 404. The server may then associate an instant messaging client with the content, block 406, the content to serve as a user interface of the instant messaging client on the second user device in response to a user interaction with a visual manifestation of the content. In various embodiments, the server may then transmit the instant messaging client and content to the second user device, block 408.

As is further shown, the server may then receive an instant message from the second user device, block 410. In some embodiments, the server may next transmit the instant messaging client and the instant message to the first user device, block 412, to facilitate display of the instant message on the first user device in conjunction with the content, the content also serving as a second user interface of the instant messaging client on the first user device. In one embodiment, the server may second transmit the instant messaging client and the instant message to some or all of a plurality of user devices known to the server as having the content, block 412.

FIG. 5 illustrates an exemplary screen shot including an object/content displayed to a user of a first computing device, the object being associated with a user of a second computing device. As described above, the object/content, such as the photograph illustrated in FIG. 5, may be highlighted (illustrated here with an outline around the photograph) to indicate when the user of the second computing device is online and available to participate in an IM conversation.

FIG. 6 illustrates an exemplary screen shot including an object/content and an associated instant messaging conversation displayed to a user of a first computing device. As shown, the instant-messaging conversation with a user of a second computing device, that user being associated with the object/content, may have been initiated by the user of the first computing device by hovering a visual representation of a mouse cursor over the object/content and typing. As described above, in some embodiments, the user of the first computing device need not even click the mouse on the object/content to start the instant messaging conversation.

FIG. 7 illustrates an example computer system suitable for use as a user computing device or server to practice various embodiments of the present invention. As shown, computing system 700 includes a number of processors or processor cores 702, and system memory 704. For the purpose of this application, including the claims, the terms “processor” and “processor cores” may be considered synonymous, unless the context clearly requires otherwise. Additionally, computing system 700 includes mass storage devices 706 (such as diskette, hard drive, compact disc read only memory (CDROM) and so forth), input/output devices 708 (such as display, keyboard, cursor control and so forth) and communication interfaces 710 (such as network interface cards, modems and so forth). The elements are coupled to each other via system bus 712, which represents one or more buses. In the case of multiple buses, they are bridged by one or more bus bridges (not shown).

Each of these elements performs its conventional functions known in the art. In particular, system memory 704 and mass storage 706 may be employed to store a working copy and a permanent copy of the programming instructions implementing, in whole or in part, IM client 206 and client providing logic 212, collectively denoted as 722. The various components may be implemented by assembler instructions supported by processor(s) 702 or high-level languages, such as C, that can be compiled into such instructions.

The permanent copy of the programming instructions may be placed into permanent storage 706 in the factory, or in the field, through, for example, a distribution medium (not shown), such as a compact disc (CD), or through communication interface 710 (from a distribution server (not shown)). That is, one or more distribution media having an implementation of the agent program may be employed to distribute the agent and program various computing devices.

The constitution of these elements 702-712 are known, and accordingly will not be further described.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present invention. This application is intended to cover any adaptations or variations of the embodiments discussed herein. Therefore, it is manifestly intended that the embodiments of the present invention be limited only by the claims and the equivalents thereof.

What is claimed is:

1. A method comprising:
receiving, by a first computing device, an object or message associated with a user of a second computing device;
visually manifesting on the first computing device, by the first computing device, the object or message to enable viewing of the object or message by a user of the first computing device; and
in response to detecting a user interaction with the visual manifestation of the object or message, changing, by the first computing device, the visual manifestation of the object or message to facilitate the user of the first computing device in engaging the user of the second computing device in an instant messaging conversation, the changed visual manifestation of the object or message serving as a user interface of an instant messaging client of the first computing device.

2. The method of claim 1, wherein the instant messaging client is local to the first computing device and the user of the second computing device is an instant messaging contact known to the instant messaging client.

3. The method of claim 1, further comprising receiving, by the first computing device, the instant messaging client with the object or message, the instant messaging client being associated with the object or message.

4. The method of claim 1, wherein the users of the first and second computing devices are members of a social network.

5. The method of claim 1, wherein said visually manifesting includes facilitating the user of the first computing device in determining whether the user of the second computing device is available for the instant messaging conversation.

6. The method of claim 1, wherein said facilitating includes facilitating the user of the first computing device in creating an instant message to send to the user of the second computing device.

7. The method of claim 6, wherein said changing the visual manifestation of the object or message includes providing a text entry area in association with the visual manifestation of the object or message to receive and render textual input from the user of the first computing device.

8. The method of claim 6, further comprising transmitting, by the first computing device, the instant message to the user of the second computing device.

9. The method of claim 1, further comprising detecting, by the first computing device, the user interaction, the user interaction comprising a mouse-over of the visual manifestation of the object or message.

10. The method of claim 1, wherein the object or message is one of a photo, a video clip, a text object, an audio clip, an audiovisual object, location information, a product, a notification of the user of the second computing device's proximity, or a notification of an event associated with both the user of the first computing device and the user of the second computing device.

11. The method of claim 1, further comprising, in response to detecting the user interaction with the visual manifestation of the object or message, initiating, by the first computing device, an email to or a live video session with the user of the second computing device.

12. A computing device comprising:
a processor; and
logic to be operated by the processor to
receive an object or message associated with a user of another computing device,
visually manifest the object or message on the computing device to enable viewing of the object or message by a user of the computing device, and
in response to detecting a user interaction with the visual manifestation of the object or message, change the visual manifestation of the object or message to facilitate the user of the computing device in engaging the user of the other computing device in an instant messaging conversation, the changed visual manifestation of the object or message serving as a user interface of an instant messaging client of the first computing device.

13. The computing device of claim 12, further comprising the instant messaging client, the user of the other computing device being an instant messaging contact known to the instant messaging client.

14. The computing device of claim 12, wherein the logic is further configured to receive the instant messaging client with the object or message, the instant messaging client being associated with the object or message.

15. The computing device of claim 12, further comprising a network interface to couple the computing device to a social network comprising the users of the computing devices.

16. An article of manufacture comprising:
a storage medium; and
a plurality of programming instructions stored on the storage medium and configured to enable a first computing device, when operated, to
receive an object or message associated with a user of a second computing device,
visually manifest the object or message on the first computing device to enable viewing of the object or message by a user of the first computing device, and
in response to detecting a user interaction with the visual manifestation of the object or message, change the visual manifestation of the object or message to facilitate the user of the first computing device in engaging the user of the second computing device in an instant messaging conversation, the changed visual manifestation of the object or message serving as a user interface of an instant messaging client of the first computing device.

17. The article of claim 16, wherein the programming instructions are further configured to provide the instant messaging client to the first computing device.

18. The article of claim 16, wherein the programming instructions are further configured to enable the first computing device, when operated, to receive the instant messaging client with the object or message, the instant messaging client being associated with the object or message.

19. The article of claim 16, wherein the programming instructions are further configured to couple the first computing device to a social network comprising the users of the first and second computing devices.

20. A method comprising:
determining, by a server, that content of a first user device is to be provided to a second user device;
associating, by the server, an instant messaging client with the content, the content to serve as a user interface of the instant messaging client on the second user device in response to a user interaction with a visual manifestation of the content; and
transmitting, by the server, the instant messaging client and content to the second user device.

21. The method of claim 20, further comprising enrolling by the server users of first and second user devices to be members of a social network.

22. The method of claim 20, further comprising:
receiving, by the server, an instant message from the second user device; and
transmitting, by the server, the instant messaging client and the instant message to the first user device to facilitate display of the instant message on the first user device in conjunction with the content, the content also serving as a second user interface of the instant messaging client on the first user device.

23. The method of claim 22, further comprising second transmitting, by the server, the instant messaging client and the instant message to some or all of a plurality of user devices known to the server as having the content.
